(19) United States
(12) Patent Application Publication
(10) Pub. No.: US 2014/0028083 A1
(43) Pub. Date: Jan. 30, 2014

(54) BRAKING SYSTEM AND METHOD FOR CONTROLLING A BRAKING SYSTEM

(71) Applicants: Manfred Gerdes, Vaihingen/Enz (DE); wolfgang Pfeiffer, Grossbottwar (DE); Jochen Mayer, Giengen An Der Brenz (DE)

(72) Inventors: Manfred Gerdes, Vaihingen/Enz (DE); wolfgang Pfeiffer, Grossbottwar (DE); Jochen Mayer, Giengen An Der Brenz (DE)

(21) Appl. No.: 14/000,523

(22) PCT Filed: Jan. 13, 2012
(86) PCT No.: PCT/EP2012/050491

§ 371 Date: Oct. 11, 2013

(30) Foreign Application Priority Data
Mar. 2, 2011 (DE) 10 2011 004 983.5

(51) Int. Cl. B60T 13/68

(52) U.S. Cl. CPC B60T 13/68
USPC 303/6.01; 303/20

(57) ABSTRACT

A braking system includes a brake pressure provision device for providing brake pressure using a brake medium; a brake pressure compensation device; a wheel brake circuit including a wheel brake cylinder for braking a wheel, the wheel brake circuit being connected via a first actuator to the brake pressure provision device and via a second actuator to the brake pressure compensation device; and a control unit for controlling the actuators and the brake compensation device in such a way that the volume of the brake medium is adapted to a desirable brake pressure in the wheel brake circuit as a function of a predefined parameter, the brake pressure in the wheel brake circuit being reduced with the aid of the brake pressure compensation device and by opening the second actuator and closing the first actuator.

### FIELD OF THE INVENTION

The present invention relates to a braking system and a method for controlling a braking system. The present invention also relates to a utilization.

### BACKGROUND

In a motor vehicle, a brake pedal is usually actuated by a driver of the motor vehicle to decelerate the motor vehicle. In this way, a piston in a brake master cylinder, and thus a brake medium, is mechanically shifted, with the aid of a brake booster, if necessary. Wheel brake cylinders are fluidly connected via lines to the brake master cylinder so that when the piston of the brake master cylinder is hydraulically shifted, a pressure is generated at the wheel brake cylinder with the aid of the brake medium and the wheel brake cylinder brakes the particular wheel. A pressure increase thus takes place here as a result of the volume of the brake medium being shifted from the brake master cylinder to the wheel brake cylinders.

A method for shifting and storing brake fluid for a hydraulic braking system of a vehicle is known from DE 2009 028 010 B3. The braking system includes a hydraulic accumulator, a brake booster, and a brake circuit. If the brake booster is actuated passively, i.e., without the driver's involvement, volume may be automatically shifted. Brake fluid is shifted to and stored in the hydraulic accumulator, and at least a portion of the stored brake fluid is emptied from the hydraulic accumulator into the brake circuit as a function of the operating state of the braking system.

### SUMMARY

According to an example embodiment of the present invention, a braking system, in particular for a motor vehicle, includes a brake pressure provision device, which brake pressure provision device includes at least one brake pressure provision chamber for providing brake pressure with the aid of a brake medium. The braking system includes a brake pressure compensation device, including at least one brake pressure compensation chamber. The braking system further includes at least one wheel brake circuit including at least one wheel brake cylinder for braking a wheel, the wheel brake circuit being connected, via a first actuator, to the brake pressure provision chamber and, via a second actuator, to the brake pressure compensation chamber. The braking system further includes a control unit configured to control the actuators and the brake pressure compensation device in such a way that the volume of the brake medium is adapted for a desirable brake pressure in the wheel brake circuit as a function of a predefined parameter, the brake pressure in the wheel brake circuit being reduced with the aid of the brake pressure compensation device and by opening the second actuator and closing the first actuator.

According to an example embodiment, a method for controlling a braking system, for example, the above-described braking system, includes providing a predefined brake pressure using a brake medium with the aid of a brake pressure provision device; applying the provided brake pressure to at least one wheel brake circuit including at least one wheel brake cylinder to brake a wheel, the wheel brake circuit being connected via a first actuator to a brake pressure provision chamber of a brake pressure provision device and via a second actuator to a brake pressure compensation chamber of the brake pressure compensation device; and adapting the provided brake pressure. In an example embodiment, the volume of the brake medium is shifted for the predefined brake pressure in the wheel brake circuit with the aid of the brake pressure compensation device and at least one actuator as a function of a predefined parameter, and the brake pressure in the wheel brake circuit is reduced with the aid of the brake pressure compensation device and by opening the second actuator and closing the first actuator.

An advantage achieved by described example embodiments of the present invention is that fewer valves and drives, e.g., motors, may be used for brake boosters, anti-lock brake (ABS)/electronic stability program (ESP) modulators, or plungers for blending in the case of recuperations. Moreover, a haptic feedback effect is also possible for a driver, who actuates a brake pedal, with the aid of the braking system. Likewise, the braking system allows less energy to be used and thus also less CO2 to be emitted by the vehicle, since, with the aid of the braking system, drives or pressure provision arrangements, such as brake cylinders, etc., do not work against one another. Predefined parameters may be made available with the aid of a sensor, e.g., an ABS, ESP, or anti-slip regulation (ASR) sensor. Depending on the detected value, the control unit may check whether or an extent to which the brake medium volume is to be adapted downstream from the brake pressure provision device.

An underlying idea of example embodiments of the present invention thus lies in the volume of the brake medium being adaptable in the wheel brake circuit or at the wheel brake cylinders, depending on the situation. To adapt the braking action, the volume of the braking system is, for example, shifted to the brake pressure compensation device or is made available in the wheel brake circuit by the brake pressure compensation device. In this case, the control unit is, for example, connected via sensors, e.g., ABS sensors, which detect an imminent blocking of a wheel. Here, the control unit controls the corresponding actuator to prevent more brake medium volume from being shifted to the wheel brake cylinder of the wheel. The brake pressure at the wheel brake cylinder is therefore not further increased.

According to one advantageous example embodiment of the present invention, the brake pressure compensation device is designed as an auxiliary brake pressure provision device to be able to completely assume the function of the brake pressure provision device if the latter fails, thus increasing the availability and reliability of the braking system. Furthermore, other redundancies for the brake pressure provision device may be dispensed with, so that the braking system may be manufactured cost-effectively overall. Furthermore, the control unit may for this purpose be connected to a sensor which detects a position of a brake pedal, for example, and to a sensor which detects a failure of the brake pressure provision device. In the event of a failure of the brake pressure provision device, the control unit then controls the brake pressure compensation device in such a way that a driver is at least able to stop the motor vehicle in a controlled manner.

According to an advantageous example embodiment, a brake pressure predefining device cooperates with the control unit in such a way that the brake pressure is lower than or equal to the desirable brake pressure which is predefined by the brake pressure predefining device. An advantage thereby achieved is that a recuperation of braking energy is thus made possible. The driver of the motor vehicle uses the brake pressure predefining device to predefine a certain desired brake pressure to decelerate the motor vehicle. The control unit then controls the brake pressure according to the desired deceleration in such a way that a portion of the deceleration may be converted into electrical energy using the drive of a generator, while still achieving the desired braking action.

According to an advantageous example embodiment of the present invention, the brake pressure compensation device and/or the brake pressure provision device include(s) a piston-cylinder system and, in particular, is/are provided with a brake medium reservoir. An advantage thus achieved is that the brake pressure may be provided with the aid of the piston-cylinder system and/or the brake pressure may be compensated for in a simple and reliable manner. In this case, it is possible that only the brake pressure provision device is provided with a brake medium reservoir. It is also possible that both the brake pressure compensation device and the brake pressure provision device are provided respective brake medium reservoirs.

According to an advantageous example embodiment, at least one actuator is designed as a valve, in particular as a solenoid valve or as a control valve. As a result, the shifting of the brake medium volume may be controlled in a simple and cost-effective manner. If the valve is designed as a solenoid valve, a rapid control is possible; if the valve is designed as a control valve, a constant control of the shifting of the brake medium volume is possible.

According to an advantageous example embodiment, the brake pressure compensation device and the brake pressure provision device are both connected to at least one brake medium reservoir. An advantage thus achieved is that the brake medium volume, which is, for example, shifted during ABS control interventions from the brake pressure provision device to the brake pressure compensation device on average over time, may be made available again to the brake pressure compensation device in a simple manner.

According to an advantageous example embodiment, the adaptation of the desirable brake pressure in an example method includes reducing the brake pressure in at least one wheel brake circuit to recuperate at least some of the braking energy with the aid of an electrical machine. An advantage thus achieved is that a braking energy recuperation, e.g., with the aid of a generator, etc., is thus made possible in a simple and reliable manner.

According to an advantageous example of the method, the adaptation of the desirable brake pressure includes controlling the at least one actuator for a predefined time period. An advantage thus achieved is that a more rapid adaptation of the desirable brake pressure is thus possible, since a corresponding actuation of the brake pressure compensation device or the brake pressure provision device requires more time.

According to an advantageous example of the method, the brake pressure is increased and reduced at at least one wheel brake cylinder with the aid of the brake pressure provision device or the brake pressure compensation device. An advantage thus achieved is that a complex and expensive synchronization of the two devices to adapt the brake pressure is thus avoided.

According to an advantageous example of the method, the brake pressure is increased at at least one wheel brake cylinder by shifting the brake medium volume using the brake pressure compensation device. In this way, in the case of an ABS control intervention, for example, during which a pressure buildup and a pressure reduction occur several times, a scenario where the brake medium volumes from the brake pressure provision device are shifted to the brake pressure compensation device such that there is no brake pressure volume available to the brake pressure provision device to build up brake pressure, can be avoided. A complex controlled recirculation of the brake medium from the brake pressure compensation device to the brake pressure provision device is thus avoided.

Additional features and advantages of the present invention are explained in the following with respect to example embodiments and the drawing.

### BRIEF DESCRIPTION OF THE DRAWING

FIG. 1 schematically shows a braking system according to an example embodiment of the present invention.

### DETAILED DESCRIPTION

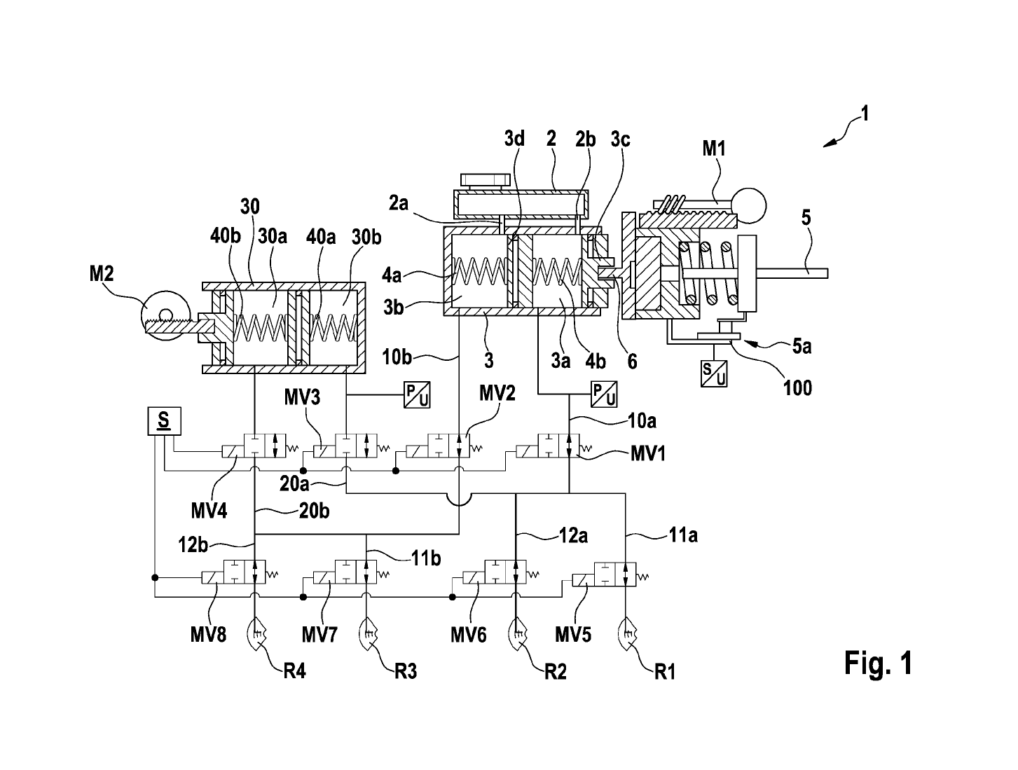

FIG. 1 schematically shows an example braking system 1 of a motor vehicle, according to an example embodiment of the present invention. Braking system 1 includes a brake pressure predefining device in the form of a pedal unit 5 as well as a brake booster 5a cooperating therewith. Brake booster 5a includes a first motor M1. The driver's braking intent may in this case be detected via a corresponding sensor, e.g., via a force or a path sensor. Furthermore, brake booster 5a is connected to a piston 3c of a tandem brake master cylinder 3 (also referred to as a brake pressure provision device). Tandem brake master cylinder 3 includes two separate chambers 3a, 3b which rest against the housing of tandem brake master cylinder 3 in the usual manner via springs 4a, 4b and against piston 3c and another piston 3d. Each of the two chambers 3a, 3b is connected upstream to a brake medium reservoir 2 via lines 2a, 2b. Downstream from tandem brake master cylinder 3, lines 10a, 10b are fluidly connected to, respectively, chambers 3a and 3b.

A first wheel brake circuit, including lines 11a, 12a, and 20a as well as solenoid valves MV5, MV6, and associated wheel brake cylinders R₁, R₂, may be acted on by the brake medium volume via line 10a. Line 10a branches into lines 11a, 12a which form separate lines for the particular wheel brake cylinder R₁, R₂.

The first wheel brake circuit includes in line 11a solenoid valve MV5 which controls the provision of the brake pressure with the aid of the brake medium at first wheel brake cylinder R₁. Downstream, line 12a includes a corresponding solenoid valve MV6 for controlling the admission of the brake medium at wheel brake cylinder R₂. Furthermore, the two lines 11a, 12a, as well as line 10a, are connected to a line 20a which, in turn, includes a solenoid valve MV3 and is connected to a first chamber 30b of a brake pressure compensation device in the form of a tandem cylinder 30. Tandem cylinder 30 includes here a motor M2 for actuating its piston and also includes corresponding springs 40a, 40b, similarly to tandem brake master cylinder 3. The second brake circuit is configured similarly to the first brake circuit and includes line 10b which is connected downstream to lines 11b and 12b, lines 11b, 12b being fluidly connected to corresponding wheel brake cylinders R₃, R₄ via valves MV7, MV8. Likewise, line 10b and lines 11b and 12b are connected to a line 20b which is connected to second chamber 30a of brake pressure compensation device 30 via a valve MV4. Furthermore, FIG. 1 shows a control unit S which is connected for the purpose of controlling valves MV1 through MV8 as well as motor M1 of brake booster 5a and motor M2 of brake pressure compensation device 30.

With reference to FIG. 1, a braking of the vehicle is described in the following for the recuperation without a control intervention and without a blending function. If brake pressure predefining device 5 is actuated, the brake pressure is increased by brake booster 5a, and piston 3c of tandem brake master cylinder 3 is shifted to the left according to FIG. 1. As a result, some of the brake medium, which is present in chambers 3a, 3b, is shifted to corresponding brake circuits 11a, 12a, 11b, 12b via lines 10a and 10b. To prevent the brake medium from shifting to brake pressure compensation device 30, solenoid valves MV3 and MV4 are closed. Solenoid valves MV5 through MV8, as well as valves MV1 and MV2, are open. Likewise, motor M2 of brake pressure compensation device 30 is not active.

Now, if a wheel is blocked at one of wheel brake cylinders R₁ through R₄, this is detected via an ABS sensor, for example, which is connected to control unit S. If it is determined, for example, that the wheel of wheel brake cylinder R₁ is blocked, control unit S energizes solenoid valve MV5 in line 11a, so that the brake pressure of wheel brake cylinder R₁ is no longer increased and the wheel is not blocked.

To reduce the brake pressure in wheel brake cylinder R₂, for example, solenoid valve MV6 is energized, solenoid valve MV1 is closed, and solenoid valve MV3 is opened, so that brake medium is able to flow from wheel brake cylinder R₂ via lines 12a and 20a into first chamber 30b of wheel brake compensation device 30. To prevent the brake pressure at wheel brake cylinder R₁ from being reduced, solenoid valve MV5 may be closed with the aid of control unit S. If the intention is to reduce the brake pressure even more after adjusting the pressure balance in brake pressure compensation device 30, motor M2 of brake pressure compensation device 30 may be actuated accordingly. Alternatively or additionally, it is possible to adapt the activation time of solenoid valve MV3 of line 20a.

To rebuild the brake pressure in the case of a control intervention by ABS at one or multiple wheel brake cylinder(s) R₁ through R₄, the pressure of the brake medium may be provided at the corresponding wheel cylinder R₁ through R₄ with the aid of tandem brake master cylinder 3. This is described in the following with reference to the example of a brake pressure increase at wheel brake cylinder R₁. To increase the pressure in the first wheel brake circuit, solenoid valve MV6 of wheel brake cylinder R₂ is initially energized, i.e., closed, to keep constant pressure at wheel brake cylinder R₂, solenoid valve MV3 of line 20a is closed, and solenoid valve MV1 of line 10a is opened, so that brake medium is shifted from and with the aid of tandem brake master cylinder 3 via line 10a and solenoid valve MV5 to wheel brake cylinder R₁, and a brake pressure increase therefore takes place at wheel brake cylinder R₁. In this case, when the brake pressure is to be reduced again, as described above, the brake medium is averaged over time and shifted to brake pressure compensation device 30 and no longer to brake medium reservoir 2 and tandem brake master cylinder 3.

On the other hand, a brake pressure may also be built up with the aid of brake pressure compensation device 30, described in the following, in the case of an ABS control intervention. To build up brake pressure at wheel brake cylinder R₁, solenoid valve MV1 in line 10a to tandem brake master cylinder 3 is closed, and both solenoid valve MV3 in line 20a to brake pressure compensation device 30 and solenoid valve MV5 to wheel brake cylinder R₁ are opened. In this way, the brake medium volume may then be shifted via lines 20a and 11a from brake pressure compensation device 30 to wheel brake cylinder R₁ and actuate the latter. For this purpose, motor M2 of brake pressure compensation device 30 dynamically shifts the brake medium volume from brake pressure compensation device 30 to wheel brake cylinder R₁.

For example, in order to provide a brake assistance function, an uphill start assistance function, or, in the case of a failure of tandem brake master cylinder 3, an auxiliary braking function with the aid of brake pressure compensation device 30, motor M2 is controlled by the control unit in such a way that the brake medium volume is shifted from the brake pressure compensation device 30 to the particular wheel brake cylinders R₁ through R₄. For this purpose, solenoid valves MV1 and MV2 of lines 10a, 10b are closed, and valves MV3 and MV4 of lines 20a, 20b, as well as particular ones of the valves MV5 through MV8 of wheel brake cylinders R₁ through R₄, are opened. If the intention is to reduce the pressure again, motor M2 may be actuated accordingly by control unit S, so that motor M2 shifts the piston of brake pressure compensation device 30 accordingly to shift the brake medium volume back in brake pressure compensation device 30 from wheel brake cylinders R₁ through R₄.

To provide an ESP and/or traction control function, control unit S controls solenoid valves MV1 and MV2 of lines 10a and 10b in such a way that they are closed. As a result, the brake medium volume is no longer shifted from tandem brake master cylinder 3 to wheel brake cylinders R₁ through R₄. At the same time, solenoid valves MV3 and MV4 of lines 20a, 20b are energized, i.e., opened, with the aid of control unit S, and motor M2 is actuated, so that the brake medium volume is shifted from brake pressure compensation device 30 to the particular wheel brake cylinders R₁ through R₄. If the particular solenoid valves MV5 through MV8 of wheel brake cylinders R₁ through R₄ are opened and/or closed at and for different times, the brake pressure may be individually controlled at the particular wheel brake cylinders R₁ through R₄. However, to reduce the brake pressure, motor M2 is actuated accordingly with the aid of control unit S. In order to allow the brake pressure to be reduced more rapidly at wheel brake cylinders R₁ through R₄, motor M1 may additionally also be actuated with the aid of control unit S, so that the corresponding piston is shifted in tandem brake master cylinder 3 and the brake medium may flow back into tandem brake master cylinder 3. For this purpose, valves MV1 and MV2 are designed as control valves, to control flow such that the brake medium volume flows through lines 10a, 10b back to tandem brake master cylinder 3, and not from tandem brake master cylinder 3 back into wheel brake cylinders R₁ through R₄.

According to an example embodiment, in order to enable a “blending” function for hybrid and electric vehicles for recuperation with the aid of the braking system shown according to FIG. 1, control unit S actuates valves MV1 and MV2 of lines 10a, 10b and closes them to maintain the pressure of the brake medium in tandem brake master cylinder 3. At the same time, solenoid valves MV3 and MV4 are opened with the aid of control unit S, so that the brake medium volume may be shifted from wheel brake cylinders R₁ through R₄ via opened solenoid valves MV5 through MV8 to brake pressure compensation device 30. Further, for example, control unit S controls motor M2 of brake pressure compensation device 30 in such a way that the brake pressure desired by the driver overall for a desirable deceleration is provided, which results from the sum of the deceleration due to the remaining residual brake pressure in wheel brake cylinders R₁ through R₄ and the deceleration due to the drive torque of an electrical machine for the recuperation. A driver of the motor vehicle therefore does not receive a feedback effect at the brake pressure predefining device, in particular a pedal.

Although the present invention has been described above on the basis of one preferred example embodiment of a system, it is not limited thereto, but may be modified in multiple ways.

For example, more than two brake circuits or more than two wheel brake cylinders are possible per wheel brake circuit. Likewise, it is possible to fluidly connect the brake pressure compensation device 30 to the brake medium reservoir 2 of the brake pressure provision device 3 in order to thus enable an easy bleeding of the braking system.

To sum up, example embodiments of the present invention provide the advantage of being able to provide control interventions such as ABS, ESP, etc., and/or a blending function for hybrid and electric vehicles using fewer components, e.g., fewer valves for providing a brake boosting.

1-12. (canceled)

13. A braking system comprising:
a brake pressure provision device for providing brake pressure using a brake medium;
a brake pressure compensation device;
a first wheel brake circuit that:
includes at least one wheel brake cylinder for braking a first wheel;
is connected via a first actuator to the brake pressure provision device; and
is connected via a second actuator to the brake pressure compensation device; and
a control unit configured to control the first and second actuators and the brake pressure compensation device to adapt a volume of the brake medium in the first wheel brake circuit to a particular brake pressure as a function of a predefined parameter, wherein brake pressure in the first wheel brake circuit is reducible using the brake pressure compensation device by opening the second actuator and closing the first actuator.

14. The braking system of claim 13, wherein the brake pressure compensation device is arranged to be used as an auxiliary brake pressure provision device.

15. The braking system of claim 13, wherein the control unit is configured to perform a control to set the brake pressure to a value that is less than or equal to a brake pressure value defined by a brake pressure predefining device.

16. The braking system of claim 13, wherein the brake pressure compensation device and the brake pressure provision device each includes a piston-cylinder arrangement, and each of at least one of the brake pressure compensation device and the brake pressure provision device is directly coupled to a brake medium reservoir.

17. The braking system of claim 13, wherein the first actuator is a valve.

18. The braking system of claim 13, wherein the brake pressure compensation device and the brake pressure provision device are jointly connected to at least one brake medium reservoir.

19. The braking system of claim 13, wherein the braking system is of a motor vehicle.

20. The braking system of claim 13, wherein:
the brake pressure provision device includes a first brake pressure provision chamber;
the brake pressure compensation device includes a piston-cylinder system, a first brake pressure compensation chamber, and a motor for actuating a piston of the piston-cylinder system;
the first wheel brake circuit is connected:
via the first actuator to the first brake pressure provision chamber; and
via the second actuator to the first brake pressure compensation chamber;
the brake pressure in the first wheel brake circuit is further reducible after adjusting a pressure balance in the brake pressure compensation device by actuating the motor; and
the braking system is configured to build up the brake pressure in the first wheel brake circuit by opening the second actuator, closing the first actuator, and actuating the motor to dynamically shift the volume of the brake medium from the brake pressure compensation device to the at least one wheel brake cylinder of the first wheel brake circuit.

21. The braking system of claim 20, wherein:
the brake pressure provision device further includes a second brake pressure provision chamber;
the brake pressure compensation device is a tandem cylinder device that further includes a second brake pressure compensation chamber;
the braking system includes a second wheel brake circuit that includes at least one wheel brake cylinder for braking a second wheel;
the second wheel brake circuit is connected:
via a third actuator to the second brake pressure provision chamber; and
via a fourth actuator to the second brake pressure compensation chamber.

22. The braking system of claim 21, wherein the control unit is configured to perform a control to set the brake pressure to a value that is less than or equal to a brake pressure value defined by a brake pressure predefining device.

23. The braking system of claim 21, wherein the brake pressure provision device includes a piston-cylinder arrangement and is coupled to a brake medium reservoir.

24. The braking system of claim 21, wherein at least one of the first and second actuators is a valve.

25. The braking system of claim 21, wherein at least one of the first and second actuators is one of a solenoid valve and a control valve.

26. The braking system of claim 21, wherein the brake pressure compensation device and the brake pressure provision device are jointly connected to a brake medium reservoir.

27. The braking system of claim 26, wherein the brake pressure provision device includes a piston-cylinder arrangement and is directly coupled to the brake medium reservoir.

28. A method for controlling a braking system, the method comprising:
applying a predefined brake pressure, created using a brake medium and a brake pressure provision device, to a wheel brake circuit that:
includes at least one wheel brake cylinder for braking a wheel;
is connected via a first actuator to the brake pressure provision device; and
is connected via a second actuator to a brake pressure compensation device; and
adapting the applied brake pressure, wherein:
the adapting includes shifting a volume of the brake medium in the wheel brake circuit using the brake pressure compensation device, by a control unit controlling at least one of the first and second actuators, and based on a predefined parameter; and
the control unit is configured to perform the shifting to reduce the brake pressure in the wheel brake circuit using the brake pressure compensation device by opening the second actuator and closing the first actuator.

29. The method of claim 28, wherein the adapting includes reducing the brake pressure in the wheel brake circuit to recuperate at least some braking energy with the aid of an electrical machine.

30. The method of claim 28, wherein the adapting includes controlling for a predefined time period at least one of (a) at least one of the first and second actuators and (b) at least one of a plurality of actuators that each is associated with a respective one of the at least one brake cylinder.

31. The method of claim 28, wherein the adapting includes increasing and reducing the brake pressure at at least one of the at least one wheel brake cylinder using one of the brake pressure provision device and the brake pressure compensation device.

32. The method of claim 28, wherein the shifting includes increasing the brake pressure at at least one of the at least one wheel brake cylinder.

33. The method of claim 28, wherein:
the wheel brake circuit:
is connected via the first actuator to a brake pressure provision chamber of the brake pressure provision device; and
is connected via the second actuator to a brake pressure compensation chamber of a piston-cylinder arrangement of the brake pressure compensation device;
the brake pressure compensation device includes a motor for actuating a piston of the piston-cylinder arrangement;
the adapting of the applied brake pressure is performed to attain a predefined brake pressure; and
the control unit is further configured to:
reduce the brake pressure in the wheel brake circuit after adjusting a pressure balance in the brake pressure compensation device by actuating the motor; and
build up the brake pressure in the wheel brake circuit by opening the second actuator, closing the first actuator, and actuating the motor to dynamically shift the brake medium volume from the brake pressure compensation device to the at least one wheel brake cylinder of the wheel brake circuit.

34. The method of 33, wherein the method comprises, with the aid of an electrical machine, reducing the brake pressure in the wheel brake circuit to recuperate at least some braking energy takes place.
